(19) United States
(12) Patent Application Publication
(10) Pub. No.: US 2006/0051183 A1
(43) Pub. Date: Mar. 9, 2006

(54) Ground anchors

(75) Inventors: Michael John Powell, Shropshire (GB); Brent Kirk Powell, Shropshire (GB); Jade Powell, Shropshire (GB)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Access to Design Limited, Telford (GB)

(21) Appl. No.: 11/178,696

(22) Filed: Jul. 11, 2005

Related U.S. Application Data
(63) Continuation-in-part of application No. 29/205,773, filed on May 20, 2004.

(30) Foreign Application Priority Data
Dec. 13, 2004 (GB) 0427195.3

(51) Int. Cl. F16B 25/00

(52) U.S. Cl. 411/386

(57) ABSTRACT

A ground anchor is adapted for anchoring in the ground. The anchor includes a ground engaging portion which comprises an elongate member and a spiral extending around at least part of the elongate member. The spiral has gaps therein spaced along its length.

### CROSS-REFERENCE TO RELATED PATENT APPLICATION

This patent application is a Continuation-in-Part of U.S. design patent application no. 29/205773, filed May 20, 2004, and claims the benefit of United Kingdom patent application no. 0427195.3, filed Dec. 13, 2004, the entire content of which is incorporated herein by reference.

### FIELD OF THE INVENTION

The present invention relates to ground anchors, particularly but not exclusively, for anchoring posts, such as fence posts, tethers, or guy ropes in the ground.

### BACKGROUND TO THE INVENTION

Currently anchors for fence posts generally comprise a ground-engaging portion, which is generally stake-like, and a fence post-receiving portion having a post-receiving channel.

It is often required to cement the ground engaging portion into place to provide necessary vertical and lateral support for the post e.g. to prevent movement of the anchor in high winds or in the event of attempted unauthorised removal. When this type of anchor is placed in the ground, it is often necessary to first bore a hole in the ground with a boring machine. This displaces soil upwards out of the hole being created. Once the hole is formed, the anchoring means is placed, and may be cemented, in the hole. This process is time consuming and involves a number of awkward steps.

### SUMMARY OF THE INVENTION

The present invention provides a ground anchor adapted for anchoring in the ground, the anchor including a ground engaging portion, the ground engaging portion comprising an elongate member and a spiral extending around at least part of the elongate member wherein the spiral has gaps therein spaced along its length.

The gaps may extend inwards from the radially outer edge of the spiral, either part or all of the way to the radially inner edge of the spiral. Alternatively the gaps may extend radially outwards from the inner edge of the spiral, either part of the way or all of the way to the outer edge, or they may be spaced from both the inner and outer edges of the spiral. The gaps preferably have sides which are substantially straight.

The present invention further provides an anchor including a ground engaging portion, the ground engaging portion comprising an elongate member and a spiral member extending around at least part of the elongate member wherein the spiral member, at least over part of its length, is spaced from the elongate member.

Advantageously, material in the ground is allowed to flow between the elongate member and the spiral member as it is rotated in the ground. This results in less displacement of material from the ground than with known anchors, and preferably substantially no displacement. As a result the material in the ground is compacted around the elongate member and spiral member to enhance the anchorage strength. Also, a strong anchor is provided in one step of installation—without the need for forming a hole or cementing. In addition, the spacing of the spiral member from the elongate member increases the effective area covered by the elongate member and spiral member to provide enhanced anchorage against movement of the anchor in a direction parallel to the elongate member.

Preferably substantially the whole of the spiral member is spaced from the elongate member. Preferably the spiral member extends around substantially the whole length of the elongate member.

Preferably the elongate member comprises a tubular member or a solid cylindrical member. Alternatively, the elongate member may have a square, rectangular, triangular or other suitable cross-section. Preferably the elongate member comprises a first lower end and a second upper end, the lower end being arranged to enter the ground before the upper end in use. The lower end is preferably tapered or pointed at its tip. The elongate member preferably comprises a spike. The length of the elongate member will depend on its intended use. Where the anchor is for supporting a large post, it may be 1 meter or even several meters long. Where the anchor is, for example, for securing guy ropes of a tent, it may be only about 150 mm long.

Preferably the spiral member comprises a flat spiral, whose width in the radial direction may be anywhere between 5 mm and 250 mm. Typically the width of the spiral will be of the same order of size as, for example one or two times, the thickness of the elongate member. The width of the spiral may be constant over the length of the anchor, or it may vary, for example decreasing towards the lower end of the anchor. The thickness of the flat spiral may be between 1 mm and 25 mm.

The spiral member may have a constant pitch such that the number of revolutions of the spiral around a perimeter of the elongate member per unit length of the elongate member is generally constant. Alternatively, the pitch, i.e. the number of revolutions per unit length, may vary.

A first upper end of the spiral member preferably extends from a position at, or adjacent, the upper end of the elongate member. A second lower end of the spiral member preferably extends to a position spaced longitudinally from the lower end of the elongate member. The lower end of the spiral member may comprise a cutting edge.

The elongate member is preferably arranged centrally within the spiral such that each point of the spiral member is generally equidistant from the elongate member.

Spacing means may be provided to space the spiral member from the elongate member. The spacing means preferably comprises no more than 50%, more preferably no more than 25%, of the space between the spiral member and the elongate member. Most preferably, the spacing means comprises no more than 10% of the space. The spacing means preferably comprises a connecting bridge between the spiral member and the elongate member. A plurality of bridges may be provided. The bridges may be provided at regular intervals between the spiral member and the elongate member. For example, three bridges may be provided per revolution of the spiral member around the elongate member. The bridges may be between 5 mm and 100 mm wide in the circumferential direction. Preferably, the bridges may be between 10 mm and 30 mm wide. The bridges are preferably at least 3 mm long in the radial direction, but more preferably at least 5 mm long in the radial direction. The bridges are preferably rigidly connected to the spiral member and the elongate member. The spiral member, the elongate member and the connecting bridges may be formed from metal and the bridges may be rigidly connected, by welding, to the spiral member or the elongate member. Alternatively, one of the elongate member and the spiral member may be formed integrally with the bridges such that the bridges only need to be connected, by welding, to the other of the elongate member and the spiral member. As a further alternative the bridges may be formed entirely from welds that bridge the gap between the inner edge of the spiral and the elongate member.

Preferably, securing means for securing an object to be anchored is joined to the upper end of the elongate member. The securing means may comprise means for securing a post, an aircraft, a caravan, hot air balloons, marquees, masts, aerials, boats, commercial fencing, a guy rope, or any other object suitable to be anchored.

Preferably, the securing means comprises a locating portion adjacent the second end of the elongate member, and arranged to contact the surface of the ground. The locating portion preferably has a lower surface arranged generally perpendicularly to the axis of the elongate member. The locating portion may comprise a plate or a widened section of the elongate member.

The securing means may further comprise receiving means such as a receiving channel for receiving an object to be anchored, in which case the channel may have a cross-section corresponding to the object, such as a round cross-section for a round fence post or a square cross-section for a square fence post. The securing means may further comprise retaining means for retaining the object to be anchored.

The receiving means may comprise a U-bolt arrangement—for receiving another U-bolt or a chain. The receiving means may comprise drop down shackles, slotted mounting arrangements, knuckle joints or any other known receivers. The receiving means may be adjustable to receive objects of different sizes or shapes.

The anchor is preferably arranged to be installed by rotating the ground engaging portion into engagement with the ground in a single rotational step. Rotating means may be provided for rotating the anchor. The rotating means may comprise an anchor engaging portion. The engaging portion is preferably adapted to engage the securing means.

In the case of an anchor having a receiving channel, the engaging portion may comprise a member having a corresponding cross-section to be a friction fit within the channel, the member further comprising a receiving aperture for receiving a bar therethrough such that the bar is rotatable to rotate the rotating means and the anchor. The rotating means may further comprise one or more additional engaging portions having different cross-sections to correspond to the different shapes and sizes of receiving channels.

The invention further provides a method of installing an anchor, as described in the preceding paragraphs, into the ground in one step only comprising the step of rotating the anchor such that its ground engaging portion engages the ground.

An embodiment of the present invention will now be described, by way of example only, with reference to the accompanying drawings.

### BRIEF DESCRIPTION OF THE DRAWINGS

FIG. 1 shows a side view of an anchor according to a first embodiment of the invention;

FIG. 2 shows an exploded side view of part of the anchor of FIG. 1;

FIG. 3 shows a view from underneath of part of the anchor of FIG. 1;

FIG. 4 shows a partial view of a top part of the anchor of FIG. 1;

FIG. 5 shows a view from above of the anchor of FIG. 1;

FIG. 6 is a perspective view of an anchor according to a second embodiment of the invention;

FIG. 7 is a further perspective view of the anchor of FIG. 6;

FIG. 8 is a perspective view of a marker for use with the anchor of FIG. 6; and

FIG. 8 is a perspective view of a further marker for use with the anchor of FIG. 6.

### DESCRIPTION OF THE PREFERRED EMBODIMENTS

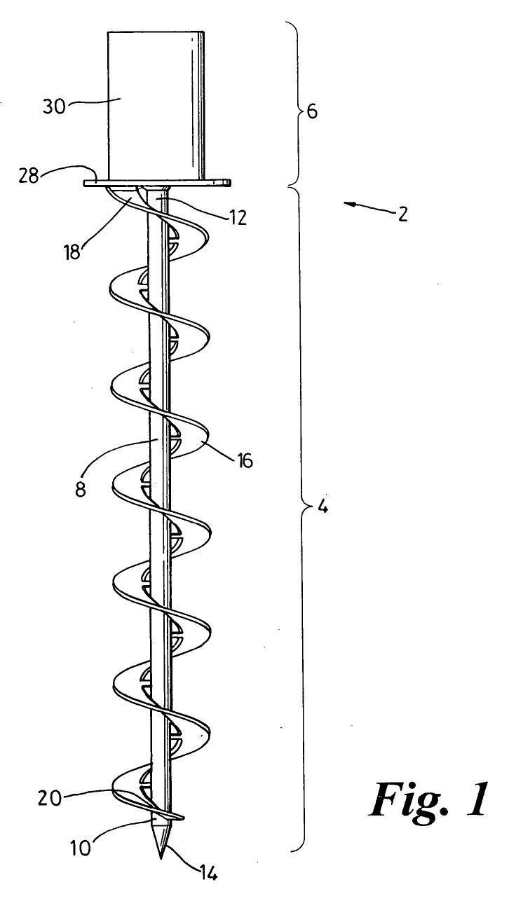

Referring to FIG. 1, an anchor 2 comprises a ground engaging portion 4 and securing means 6—both of which are formed of metal. The ground engaging portion 4 comprises an elongate member in the form of a hollow tubular spike 8 having a first lower end 10 and a second upper end 12. The spike 8 is about 900 mm long. The column or spike 8 comprises a conical point 14 at its lower end 10. The ground engaging portion 4 further comprises a spiral member in the form of a flat spiral 16, which extends around the spike 8. The spiral 16 comprises a first upper end 18 and a second lower end 20. The upper end 18 extends from a position longitudinally at the upper end 12 of the tubular spike 8. The lower end 20 of the spiral 16 extends to a longitudinal position at the base of the conical point 14 i.e. so that the tip of the spike extends beyond the lower end of the spiral. The lower end 20 of the spiral comprises a sharpened cutting edge 22 extending in a substantially radial direction. The flat spiral 16 has a width of about 30 mm in the radial direction.

In this embodiment, the pitch of the spiral 16 provides six and a quarter turns around the spike 8—as seen in FIG. 1. Therefore there is about one complete turn every 150 mm along the length of the spike 8.

The ground engaging portion 4 further comprises spacing means in the form of connecting bridges 26 that support the spiral 16 in a spaced relationship to the spike 8. Each connecting bridge 26 is in the form of a generally rectangular metal part provided integrally with the spiral 16. The spiral can therefore be considered as a continuous outer portion and the inwardly extending bridge portions 26.

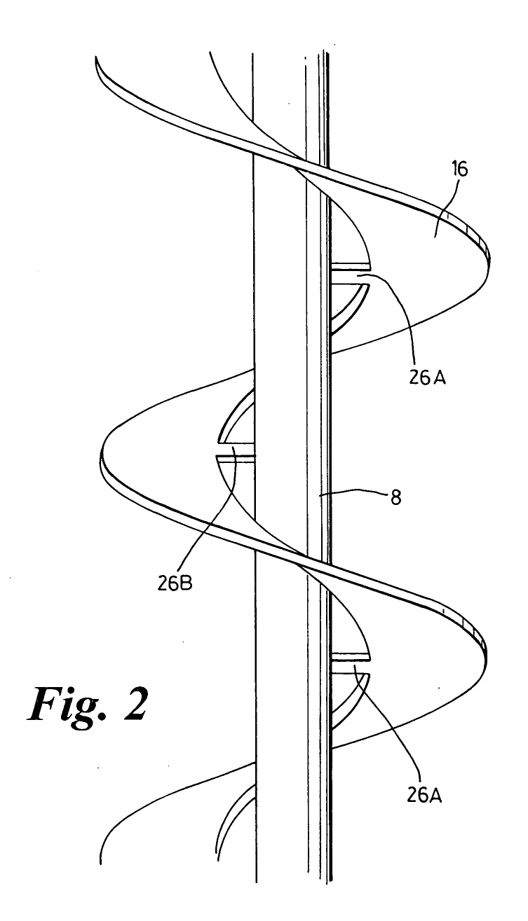

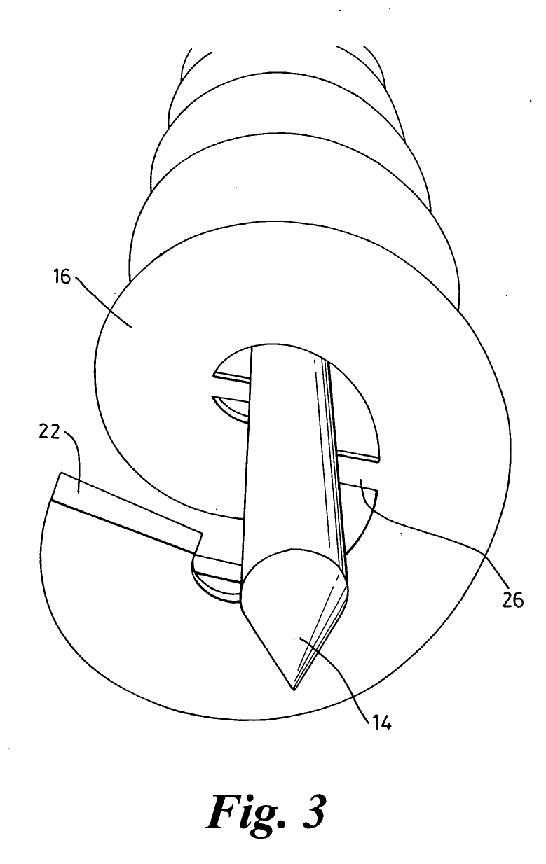

Referring to FIGS. 1 and 2, sets of connecting bridges 26 are provided at regular intervals along the length of the spiral 16. Each set comprises a first bridge 26a, a last bridge 26b, spaced by 180° in the revolution of the spiral 16 and an intermediate bridge (hidden in FIG. 2 by the spike 8) mid way between the first 26a and last 26b bridges of the set, i.e. spaced by about 90° from both the first 26a and last 26b bridge in the same set. Therefore three connecting bridges 26 are provided for each turn of the spiral. In addition bridges are provided at the upper end 18 and lower end 20 of the spiral 16 (e.g. see FIG. 3).

The connecting bridges 26 are joined to the spike 8 by welding at their radially inner ends where they contact the spike 8. This can be achieved, for example, by four spot welds for each bridge, one at each end of the upper and lower edges of the inner end of the bridge. Alternatively a single weld along the inner end of each bridge can be used. In this way a rigid securing means 6 is provided in which the spiral 16 extends around the spike 8 and is spaced from the spike 8 equally along the whole of the length of the spiral 16, by virtue of the gaps left between adjacent bridges 26. These gaps are defined between the spike 8 on the inside and the spiral 16 on the outside, and the bridges 26 at either end. The bridges 26 can, on the other hand, be considered as part of the spiral, in which case the spiral can be considered as formed from a continuous outer part, and an inner part that has the gaps in and forms the bridges.

If the spiral 16 were not to be spaced from the spike 8, a running weld along the length of the spiral 16 would be required during construction of the anchoring means 2. This is much more difficult and complex than a plurality of smaller welds.

The securing means 6 further comprises a ground plate 28, which in this embodiment is a square plate having sides about 150 mm long. The ground plate 28 is secured perpendicularly to the spike 8 by welding the second end 12 of the spike 8 into a hole 29 that is formed centrally in the plate 28. Alternatively the spike 8 can be welded simply to the underside of the plate 28. The upper end 18 of the spiral 16 is also welded to the plate 28.

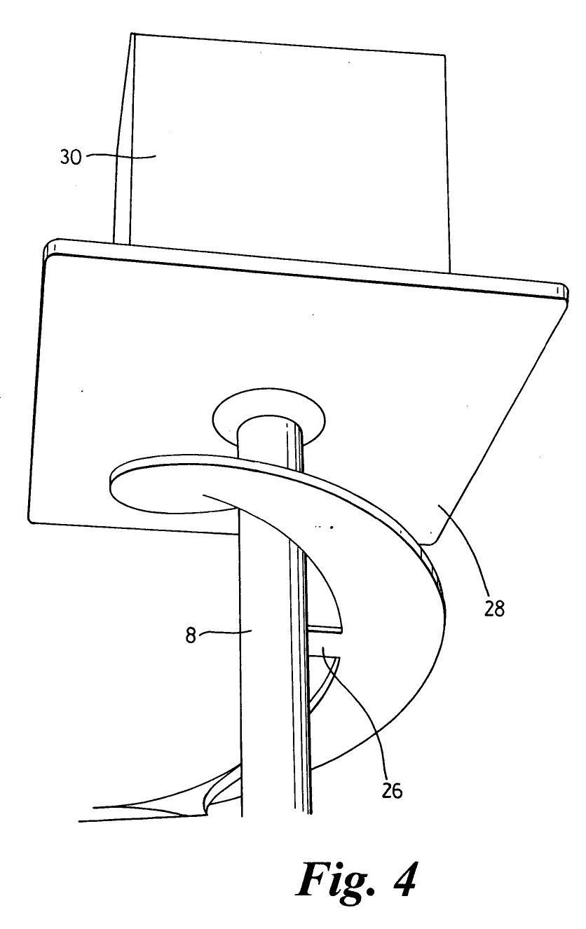

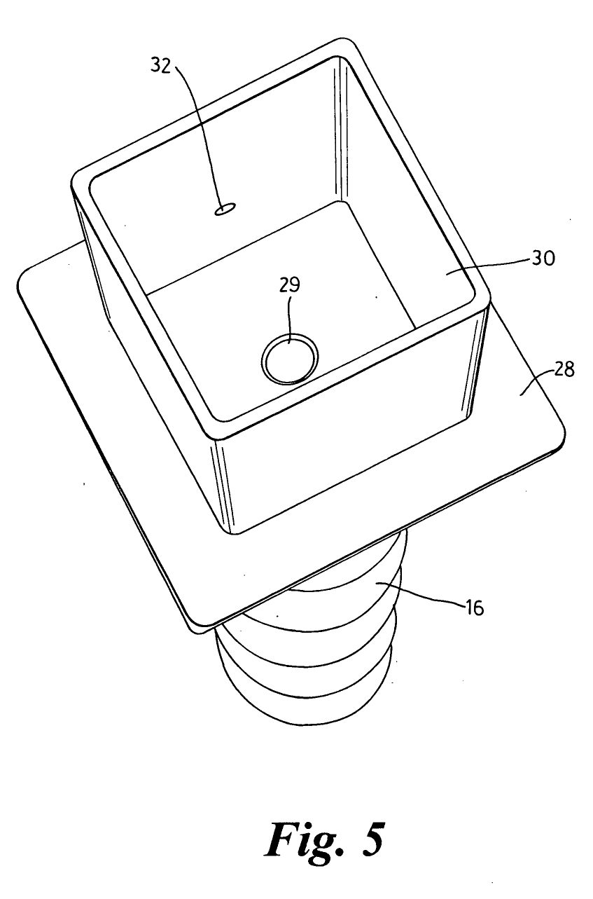

Referring to FIGS. 4 and 5, the securing means 6 further comprises receiving means in the form of a square section receiving channel 30. The receiving channel 30 has four vertical walls having a width of about 100 mm height of about 150 mm. In the centre of one of the walls, there is provided a screw hole 32 for receiving a screw for securing a post in the channel 30.

In use, the anchor 2 is placed into the ground by first piercing the ground with the conical point 14 of the spike 8. If it is required to install the anchor generally vertically, the conical point 14 should be driven generally vertically into the ground. The anchor 2 is then rotated in a screw like fashion into engagement with the ground. When the anchor 2 is first rotated, the cutting edge 22 facilitates the initial rotation by cutting through material in the ground. As the anchor 2 is further rotated the cutting edge 22 continues to have this effect. In addition, material in the ground is allowed to flow in the space, i.e. through the gaps, between the spiral 16 and the spike 8, which further facilitates the rotation process. In addition, material in the ground tends not to be displaced out of the ground and instead becomes compacted around the spike 8 and spiral 16 to enhance anchoring.

Rotation of the anchor 2 may be achieved by having a tool with an engaging head having a cross section corresponding to the internal dimensions of the receiving channel 30 to form a friction fit therewith. The tool may further comprise apertures for receiving a bar therethrough, in which the bar is used to rotate the engaging head and therefore the anchor 2. Such a tool can be provided with a plurality of differently shaped or sized heads, which may correspond to receiving channels of securing means provided on other embodiments of the present invention.

Once the under side of the plate 28 is level with, and located against, the surface of the ground, the rotation step is complete. The base of a post to be anchored is then placed in the receiving channel 30 the base of the post has a square cross section having a width of about 10 cm. Commercially available posts are slightly variable in width and therefore the square section receiving channel 30 is slightly oversized. A screw is able to be passed through the screw hole 32 and tightened against the post to clamp the post in the channel 30.

Various modifications may be made to the present invention without departing from its scope. For example, many different forms of securing means may be provided—some will have a ground plate 28, some will not. Different sizes of square section receiving channels, circular section receiving channels and any other cross sections corresponding to an object to be anchored may be provided. Other objects which may be anchored by anchoring means according to the present invention include aircraft, caravans and other comparable objects. A U-bolt arrangement or shackle arrangement may be provided for use in conjunction with ropes or other U-bolts for tying down objects such as airplanes. Securing means may comprise adjustable securing means to receive objects of different sizes and shapes.

The bridges may be formed in various ways. For example they can be made of separate pieces of metal and welded to both the spiral and the central column. Alternatively they can be formed entirely from welds that bridge the gap between the inner edge of the spiral, which in this case forms a proper helix, and the column.

The anchor may be made from any suitable material—not necessarily metal—such as a polymer or other plastics material, carbon fiber, or Kevlar™. The length of the spike or spiral may vary. The width of the spiral may also vary. The spike may be a solid member instead of a tube. The anchor does not have to be installed vertically—it may be installed horizontally or at any other desired angle.

The lower end of the anchor may take a number of different forms. For example it can be fluted or formed as a flat blade. It may also have a hardened tip, for example a carbide tip.

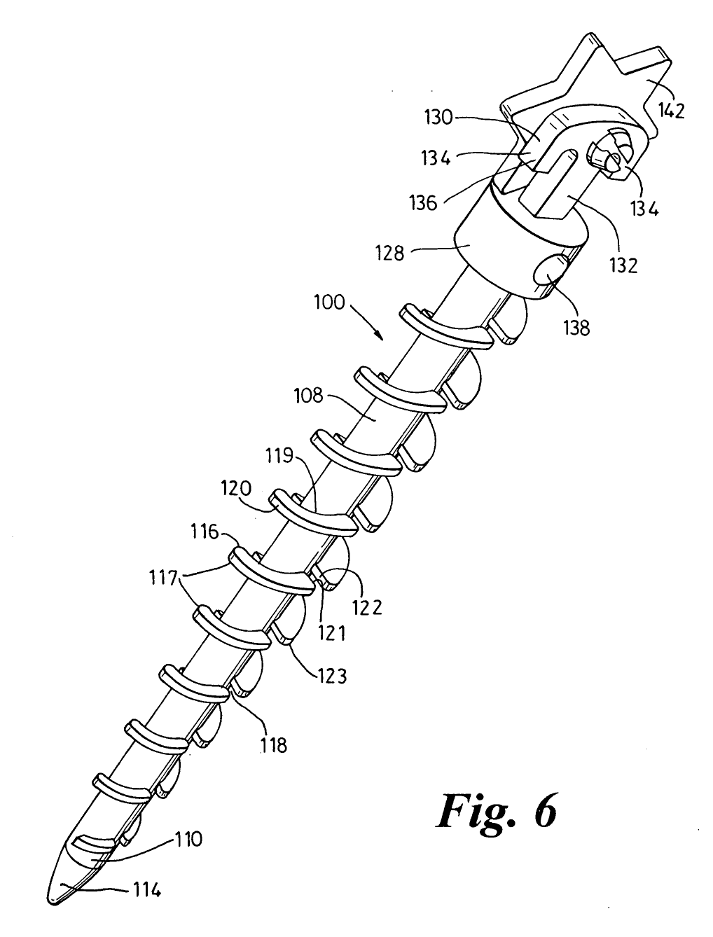

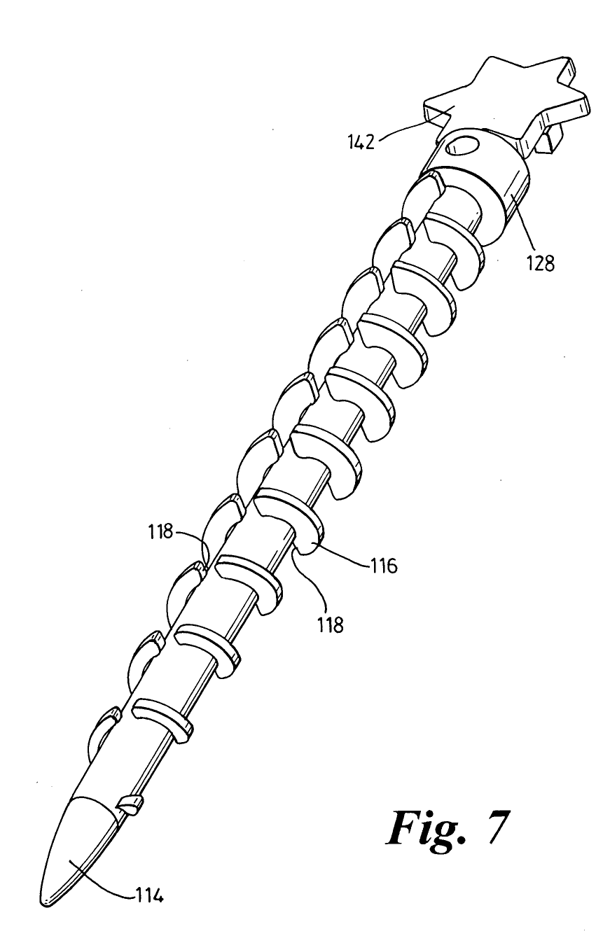

Referring to FIGS. 6 and 7 an anchor according to a second embodiment of the invention comprises a tent peg. The anchor or peg 100 is molded in one piece from plastics material. In this case glass reinforced plastic (GRP) is used, more specifically glass filled nylon. The peg 100 comprises a central spike 108 which is of circular section and constant diameter along its length, with a sharpened tip 114 at its lower end 110, and a spiral 116 extending around the spike 108. The tip 114 has a longitudinal groove 115 formed in it. A head 128 is formed at the top end of the spike which is also of circular section but of greater diameter than the spike. A hook 130 projects upwards from the top of the head 128, comprising a central vertical support portion 132 and two opposed hook portions 134 extending laterally outwards in opposite direction from the top of the support portion and having their outer ends 136 turned downwards. A hole 138 is formed through head 128, in the horizontal direction passing through, and perpendicular to, the longitudinal axis of the peg. This hole is arranged to receive a drive tool for rotating the peg to drive it into the ground.

The spiral 116 is formed in a number of discrete sections 117 with gaps 118 between them. Each section 117 forms slightly less than a half turn around the spike 108 and are aligned with each other in two sets on opposite sides of the spike 108. The gaps are therefore also in two sets aligned with each other in the longitudinal direction, the sets being on opposite sides of the spike 108. Each spiral section 117 has a radially inner edge 119 along which it is connected to the spike 108, and a radially outer edge 120. It also has an upper end 121 and a lower end 122, both of which extend in a substantially radial direction. The corners 123 where the lower ends 122 meet the outer edges 120 are slightly rounded, but sharp enough to scrape and bite into the soil as the peg is rotated. The radial width of the spiral 116 decreases gradually along the length of the peg from its top end to its bottom end.

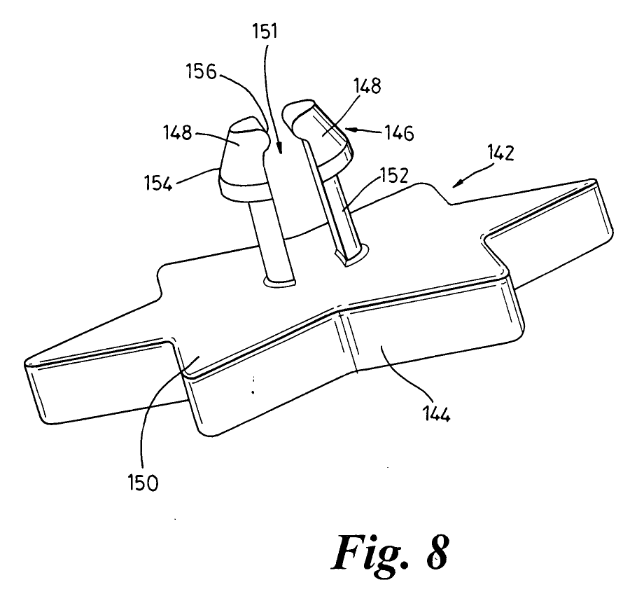

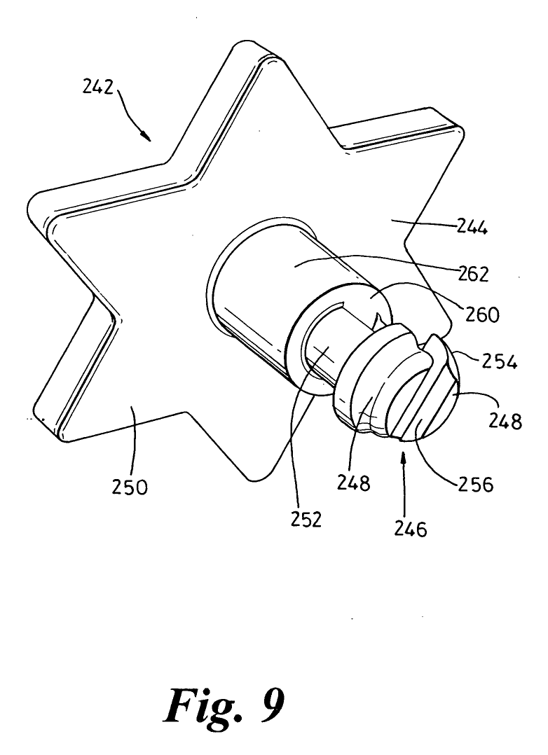

The hook 130 has a hole 140 through it arranged to have a luminous marker 142 secured in it. Referring to FIG. 8, a luminous marker 142 comprises a star shaped body 144 with a retaining clip 146 projecting from one side. The clip 146 is formed from two projections 148 projecting at right angles to the flat surface 150 of the body 144. The projections 148 are spaced apart so that there is a gap 151 between them and have a narrow flexible lower portion 152, closest to the body 144 and a wider head 154 at their upper ends. The heads 154 each form an inward projection 156 at their free ends furthest from the body 144, which narrows the end of the gap 151. They are also wider than the flexible lower portions, and together form a widened head to the clip 146. The luminous marker 142 can be attached to the peg 100 by pushing the head of the clip 146 through the hole 140 in the hook 130. The projections 148 flex together as their heads 154 pass through the hole 140, and then snap outwards again when the heads 154 pass out of the other side of the hole 140, so as to retain the marker 142 in position. The marker 142 can also be attached directly to a guy rope by pushing the guy rope between the two projections 148, which will flex apart to allow the guy rope to pass between the inward projections at the end of the clip, and then come back together as the guy rope passes the heads 154, gripping the outer surface of the guy rope between them.

In order to secure the peg 100 in the ground, the sharpened tip 114 is pushed into the ground so that the first few turns of the spiral 116 are beneath the surface. A tool, such as a screw driver, is then inserted through the drive hole 138 in the head 128 and used to rotate the peg. The spiral 116 then acts as a thread and draws the peg further into the ground. The grove 115 in the tip of the peg helps to dig out the soil into which the peg is being inserted. While the peg is being pulled downwards through the soil, the soil is being pulled upwards by the spiral 116. If the soil is very hard, then it will not move upwards. However, if it is soft, some if it will tend to be lifted out of the hole that is being formed by the peg 100. However, the gaps 118 between the spiral sections 117 allow some of the soil that is lifted upwards to fall back down again before it reaches the surface. Also, as the peg 100 is rotated, the teeth formed at the lower corners 123 of the spiral sections 117, help to cut into the soil. This reduces the tendency of the soil around the peg 100 to become so tightly compacted that rotation of the peg is prevented. The peg 100 is rotated until the under side of the head 128, which is perpendicular to the longitudinal axis of the peg, engages with the surface of the ground, where it provides support for the peg. A guy rope can then be looped round the hook 130, and the marker 142 clipped into the top of the peg 100 to make it easily visible.

It will be appreciated that a number of the markers 142 can be supplied with a number of pegs 100, so that they can be used both on the pegs and on the guy ropes of a tent as required.

In a modification to the second embodiment described above, the spiral is not completely separated into sections, but rather the gaps extend inwards from the outer edge of the spiral only part of the way in towards the spike. This still provides teeth at the outer edge of the spiral and gaps to help prevent lifting soil, but the inner part of the spiral, adjacent to the spike, is continuous and unbroken. While in theory it would be possible to form a molded anchor similar to the first embodiment, in which the gaps in the spiral are formed at the inner edge of the spiral adjacent to the central spike, this arrangement is difficult to mould, and is therefore more suited to a two-piece construction.

The specific material chosen for the anchor can clearly be selected as appropriate to suit the application. For example it can be molded from a polymer such as polypropylene or nylon, with or without glass fiber reinforcement. Alternatively it can be cast from a metal such as aluminum.

The size of the gaps 118 can obviously be varied depending on the application of the anchor. For example the gaps may only extend part of the way in from the outer edge of the spiral to the inner edge where it is joined to the central column. However, in order to function properly they need to extend radially at least 20% of the way through the spiral, more preferably at least 50% of the way through it. Also, although having the gaps formed at the outer edge of the spiral clearly makes manufacture more simple, the gaps could be formed at any position radially within the spiral. For example they could be formed at the radially inner edge of the spiral, in a similar manner to the first embodiment, or they could be formed at an intermediate position spaced from the inner and outer edges of the spiral.

Also the length of the gaps, and their spacing, in the circumferential direction can clearly be varied. For example, rather than two gaps per turn of the spiral there could be only one, or there could be more, for example three or four. The gaps may be aligned vertically as in the embodiment of FIGS. 6 and 7, or may be offset from each other.

The proportion of the spiral that is left open as gaps will also vary for different applications. Generally the greater the area of the gaps, the less the soil will be pulled out of the ground as the anchor is screwed into the ground. If the area of the spiral is taken to be the area between the helical outer edge of the spiral and the inner edge of the spiral, then the gaps will generally need to take up at least 10% of that area. For some applications they will need to take up at least 20% of that area to be effective.

Referring to FIG. 9, in a modified version of the marker of FIG. 8. Similar features are indicated by the same reference numerals increased by 100. The only modification in this version is that the two halves 248 of the clip 246 project from the flat upper surface 260 of a cylindrical spacing portion 262, which in turn projects from the centre of the rear face 250 of the marker 242. The flexible lower portions 252 of the projections 248 are therefore spaced from the rear surface of the marker by a distance equal to the height of the spacer portion 262. Referring back to FIG. 6, it will be appreciated that, when this marker 242 is attached to the peg 100, the lower portions 252 of the clip will be located within the hole in the top of the peg 100, and the star shaped body 244 of the marker will be spaced from the hook 130 on the top of the peg 100. The advantage of this is that a rope can be passed around the hook 130 so that it passes between the hook 130 and the body 244 of the marker.

What is claimed is:

1. A ground anchor adapted for anchoring in the ground, the anchor including a ground engaging portion, the ground engaging portion comprising an elongate member and a spiral extending around at least part of the elongate member wherein the spiral has gaps therein spaced along its length.

2. An anchor according to claim 1 wherein the gaps extend outwards from the inner edge of the spiral.

3. An anchor according to claim 1 wherein the gaps extend inwards from the outer edge of the spiral.

4. An anchor according to claim 1 wherein the gaps only extend part way through the spiral in the radial direction.

5. An anchor according to claim 1 wherein the gaps extend radially from the inner edge to the outer edge of the spiral.

6. An anchor according to claim 1 wherein the gaps have sides which extend in a substantially radial direction.

7. An anchor according to claim 1 wherein the spiral forms a thread arranged to draw the anchor into the ground on rotation of the anchor.

8. An anchor according to claim 1 further comprising drive means arranged to engage with a drive tool to enable rotation of the anchor.

9. An anchor according to claim 9 wherein the drive means comprises an aperture through the anchor.

10. An anchor according to claim 1 comprising supporting means at its upper end arranged to support an upright member.

11. An anchor according to claim 1 having a hook at its upper end arranged to retain a guy rope.

12. An anchor according to claim 1 having a locating portion with a surface arranged to locate against the surface of the ground when the anchor is in the ground.

13. A peg comprising: an elongate member with a spiral extending around it arranged to draw the peg into the ground on rotation of the peg; and a hook at its upper end arranged to retain a guy rope.

14. A peg according to claim 13 wherein the hook comprises a central support portion and a pair of opposed hook portions extending from opposite sides of the support portion.

15. An anchor according to claim 11 in combination with a luminous marker attachable to the anchor.

16. An anchor and luminous marker according to claim 15 wherein the luminous member is releasably attachable to the anchor.

17. An anchor and luminous marker combination according to claim 16 wherein the luminous member includes engagement means arranged to releasably engage with the anchor.

18. An anchor and luminous marker according to claim 17 wherein the engagement means is arranged to releasably engage directly with a guy rope.

19. An anchor and luminous marker according to claim 17 wherein the engagement means comprise a pair of flexible projections with a gap between them.

20. An anchor and luminous marker according to claim 15 further comprising spacing means arranged to space the body of the marker from the anchor thereby to allow a tether to pass between the body of the marker and the anchor.

21. A marker comprising a body and a clip, the clip being arranged to enable the marker to be attached to an object by being pushed through a hole in the object, and to be attached to an elongate member by gripping the outer surface of the elongate member.

22. An anchor according to claim 1 wherein the gaps are arranged such that, at least over part of its length, the spiral is spaced from the elongate member.

23. An anchor including a ground engaging portion, the ground engaging portion comprising an elongate member and a spiral member extending around at least part of the elongate member wherein the spiral member, at least over part of its length, is spaced from the elongate member.
